(19) United States
(12) Patent Application Publication
(10) Pub. No.: US 2026/0268787 A1
(43) Pub. Date: Sep. 10, 2026

(54) GENERATING EDUCATIONAL CONTENT FOR A TOPIC SENTENCE AND IRRELEVANT SENTENCE IDENTIFICATION ACTIVITY USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Joshua Singer, Claymont, DE (US); Cameron Kelley, Austin, TX (US); Alex Stanciu, Penn Valley, PA (US)

(73) Assignee: 2hr learning, Inc., Austin, TX (US)

(21) Appl. No.: 19/556,941

(22) Filed: Mar. 4, 2026

Related U.S. Application Data
(60) Provisional application No. 63/768,825, filed on Mar. 7, 2025.

(51) Int. Cl. G09B 7/00; G06Q 50/20

(52) U.S. Cl. CPC G09B 7/00; G06Q 50/205

(57) ABSTRACT

An educational content generation system for guiding an Artificial Intelligence (AI) engine to generate educational content used for a ‘topic sentence and an irrelevant sentence identification’ activity is disclosed. The educational content generation system receives a plurality of input parameters including a topic, grade level, and difficulty level. A prompt generator formulates a prompt that guides the AI engine to create the educational content based on input parameters. The AI engine generates and splits the generated educational content into a plurality of sentences. The AI engine processes the plurality of sentences to distinguish the topic sentence, supporting sentences, and irrelevant sentences. The generated sentences are validated via a quality check module to ensure the topic sentence defines a central idea and the irrelevant sentence does not support the central idea. The validated sentences are the stored in a database for use during activity practice sessions.

### CROSS-REFERENCE TO RELATED APPLICATION(S)

This application claims the benefit under 35 U.S.C. § 119(e) and 37 C.F.R. § 1.78 of U.S. Provisional Application No. 63/768,825, which is incorporated by reference in its entirety.

### FIELD OF THE INVENTION

The present invention relates in general to the field of electronics, and more specifically, to an educational content generation system for generating educational content for a user to identify a topic sentence and an irrelevant sentence.

### DESCRIPTION OF THE RELATED ART

Traditional content generation methods involve manual curation of content by educators. Such manual content generation methods are time-consuming and are also inherently static, which limits adaptability, engagement, and personalization. The manual process of developing content demand significant manual efforts as the educators carefully select or craft the content to make is appropriate for target users. This requires deep understanding of underlined topic, logical coherence, and instructional objectives. Additionally, the educators need to ensure that the content aligns with the appropriate grade level and comprehension abilities of students.

Moreover, content generation methods tend to be static, meaning they offer little variation or adaptability once created. Once the content is generated, it remains unchanged, requiring educators to develop new materials whenever they wish to introduce fresh examples or varied difficulty levels. This rigidity is particularly problematic in differentiated instruction, where students have diverse learning paces and needs. While some students may find the provided examples too easy, others may struggle to grasp the concept due to the lack of explanations.

Furthermore, the traditional content generation methods are unable to provide immediate feedback. When students complete these exercises, they must wait for the educators to manually check their responses and provide corrections. This delay hinders the learning process, as students may not remember their reasoning by the time feedback is given. Additionally, traditional content generation methods often fail to engage students effectively. Static, text-based exercises may not appeal to learners who thrive in interactive, visual, or gamified environments. A lack of engagement can lead to decreased motivation and lower retention of concepts. Also, if the teacher needs to modify the content generated for different proficiency levels, they must manually edit or recreate the content. This additional workload can be overwhelming, particularly for educators who are already managing extensive lesson planning, grading, and administrative duties.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary activity generation and grading system.

FIG. 2 depicts an educational content generation system for generating educational content for a topic sentence and irrelevant sentence identification activity.

FIG. 3 depicts an education content generation process for generating educational content for the topic sentence and irrelevant sentence identification activity.

FIG. 4 depicts an educational content validation process, which is an embodiment of the educational content generation process of FIG. 3.

FIG. 5 depicts an output generation process, which is an embodiment of the educational content generation process of FIG. 3.

FIG. 6 is an exemplary user interface depicting a generated ‘topic sentence and irrelevant sentence identification’activity on an online learning platform.

FIGS. 7-14 are exemplary user interfaces depicting the interaction of the user with the generated ‘topic sentence and irrelevant sentence identification’ activity via the online learning platform.

FIG. 15 depicts an exemplary network environment in which the educational content generation system of FIG. 2 and the educational content generation process of FIG. 3 may be practiced.

FIG. 16 depicts an exemplary computer system.

### DETAILED DESCRIPTION

An educational content generation system for guiding an Artificial Intelligence (AI) engine to generate educational content, where a user identifies a topic sentence and an irrelevant sentence within the generated educational content. The process begins by receiving a plurality of input parameters through a user interface, where the input parameters include a topic, grade level, and difficulty level of the content to be generated. A prompt generator then formulates a prompt that guides the AI engine to generate the educational content. The AI engine generated the education content aligned to the input parameters and then splits the generated educational content into a plurality of sentences. The AI engine further identifies a topic sentence, supporting sentences, an irrelevant sentence from the generated plurality of sentences. The generated plurality of sentences are then validated, via a quality check module, to ensure that the topic sentence defines the central idea of the educational content, while the irrelevant sentence does not support the central idea. The validated sentences are then stored in a database in a predefined format such that the content may be displayed to a user via an online learning platform as needed.

The difficulty level of the educational content can be adjusted to cater to varying complexities based on the input parameters. The AI engine ensures that each of the generated educational content contains a single topic sentence, multiple supporting sentences, and one irrelevant sentence. The process involves segmenting the educational content into sentences for effective identification. The segmented sentences are then run through a quality check to ensure that the topic sentence focusses on the central idea of the educational content while the irrelevant sentences does not focus on the central idea. Sentences failing the quality check are discarded.

The validated sentences are combined into a single data structure in the form of a question, which is then stored in a database for future usage. A heuristic method checks the irrelevance of the generated plurality of sentences, confirming adherence of the sentences to the criteria of abiding by the central idea of the educational content. Furthermore, a schema based validation is done to ensure that the sentences are in a predefined format such as JSON, and a concurrency control mechanism manages simultaneous AI engine calls, preventing overload of the AI engine.

The educational content generation system and educational content generation process set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

A programmatic AI engine management system generates decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics. For example, in an educational context, generating customizable educational activity in which the user identifies a relevant topic sentence and remove one tangentially irrelevant sentence.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce educational content on various topics at different difficulty and grade levels, ensuring each content has a single topic sentence, multiple supporting sentences, and exactly one sentence which does not belong to the main theme of the content, that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

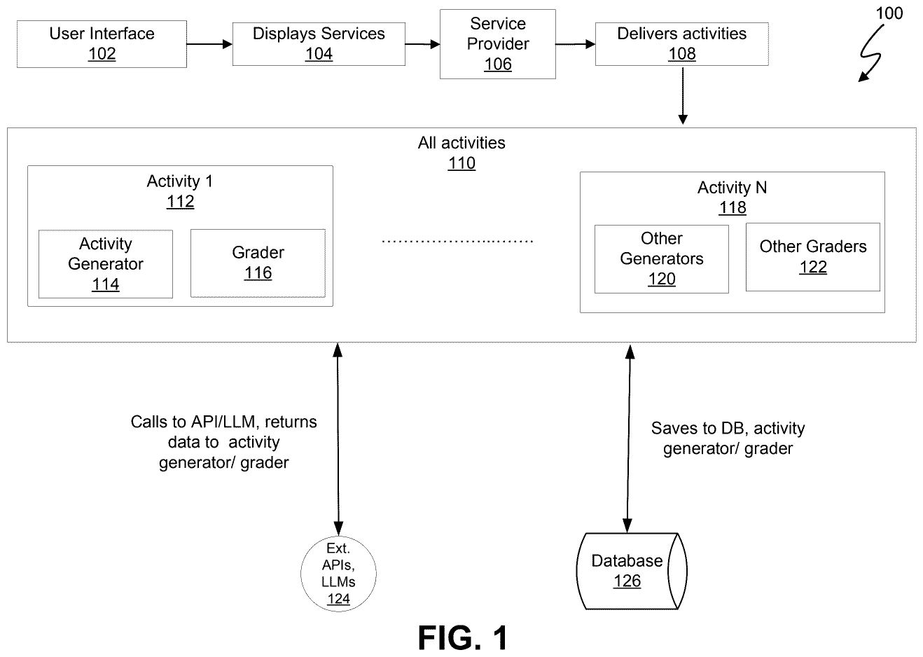

FIG. 1 depicts an exemplary activity generation and grading system 100.

The activity generation and grading system 100 is an AI-powered educational platform designed to automate the generation and grading of a plurality of language-based exercises. The AI-powered educational platform, which is an online learning platform (not shown in the figure) is designed to enhance reading comprehension skills for K-12 students. A user interface 102, integrated within the online learning platform, provides multiple educational services 104 on behalf of a service provider 106. The service provider 106 includes a plurality of services in the form of educational platforms. The user can select the service of his/her choice from the user interface 102. The user interface 102 presents a variety of activities 108, such as reading comprehension question generation, appositive exercises, sentence completion tasks, subordinating conjunction exercises, topic sentence generation, and so on. All activities 110 are dynamically created by their corresponding activity generator and assessed by a grader, ensuring an enhanced learning experience for users. The variety of activities 108 includes ‘Activity 1’ 112 generated by an activity generator 114 to ‘Activity n’ 118 generated by another generator 120. The ‘Activity 1’ 112 in the present disclosure includes a content generation including plurality of sentences.

The activity generator 114 and the corresponding activity grader 116 orchestrate the entire process of activity generation and interaction of a user with the generation activity, via an online learning platform. The activity generator 114 and the other activity generators 120 generate the variety of activities 110, evaluate workflows, import necessary modules, and populate prompts with appropriate variables to generate various exercises, such as reading comprehension questions, sentence completion tasks, and grammar exercises. For instance, the activity generator 114 generates the education content and plurality of sentences based on the educational content. For this purpose, the activity generator 114 fetches input data using one or more external APIs (Application Programming Interface) 124 and LLM (Large Language Models). The input data may include topic, user's grade level, and difficulty level specifying the complexity of the educational content. The input data may vary based on the type of activity generated by the corresponding activity generator. The activity generator 114 ensures that the generated educational content and plurality of sentences based on the educational content align with the user's grade level and past performance. The activity generator 114 and the grader 116 generate and evaluate user's performance on the learning activities dynamically.

Once the activity is generated and shared with a user for practicing, the grader 116 takes over the grading process for the user response submitted for shared activity. Similarly, activities generated and shared by the other generators 120 will be evaluated by other graders 122. The grader 116 assesses the user's responses to determine correctness using methods such as semantic similarity analysis and key sentence extraction. The grader 116 not only provides a binary correct/incorrect grading but also offers detailed explanations for incorrect answers. These explanations include textual evidence, structured reasoning, and adaptive hints or feedbacks to help learners understand their mistakes. The grader 116 can also dynamically adjust question difficulty based on the user's past performance, ensuring a gradual and adaptive learning experience.

For example, in the case of education content generation for a user to identify a topic sentence and an irrelevant sentence within the educational content, the activity generator 114 extracts the plurality of sentences from the educational content, and processes the generated plurality of sentences generate the topic sentence, supporting sentences, and the irrelevant sentence.

Once the activity is generated by the activity generator 114, the grader 116 evaluates the response by checking its correctness against the supporting text from the educational content. The grader 116 may use techniques such as semantic similarity analysis to determine whether the text fully supports the answer. If the generated activity is incorrect, the grader 116 provides structured explanations, including textual evidence and reasoning, to help the learner understand their mistake. This feedback mechanism enhances the learning experience, ensuring adaptive difficulty adjustments and preventing question redundancy. This is for the case of the activity generated by the activity generator 114. However, when other activity generators generate the corresponding activity like topic sentence generation, appositive generation, and so on, the corresponding grader evaluates the response provided by the user may provide a response to the user in binary format (Yes/No), an explanation when the answer provided by the user is incorrect, a hint to the user in case of the incorrect answer, and so on.

The one or more external APIs 124 or LLMs are used to either exchange of generate data for different components, specifically the activity generator 114 and the grader 116. For example, the one or more APIs 120 act as communication bridges, ensuring seamless data exchange between the user interface 102, the activity generator 114, and the grader 116. When the user interacts with the user interface 102, such as selecting an eliminate irrelevant sentences activity, the one or more external APIs 124 retrieve the relevant education content, and user settings (including topic, grade level and difficulty level). This information is then sent to the activity generator 114, which processes the data, generates the plurality of sentences based on the educational content, and formats it for presentation to the user.

Once the user submits the response, the one or more external APIs 124 exchanges this response, along with the plurality of sentences including the topic sentence, supporting sentences, and the irrelevant sentence, to the grader 116 for grading. The grader 116 assesses the correctness of the answer, often using techniques like semantic similarity analysis and key sentence extraction. If the response is incorrect, the grader generates an explanation, referencing textual evidence to clarify why the selected choice is wrong and what the correct answer should be. The final feedback is then sent back to the user interface through the one or more external APIs 124, ensuring a smooth and efficient learning experience. Finally, the generated activity along with the response is stored in a database 126.

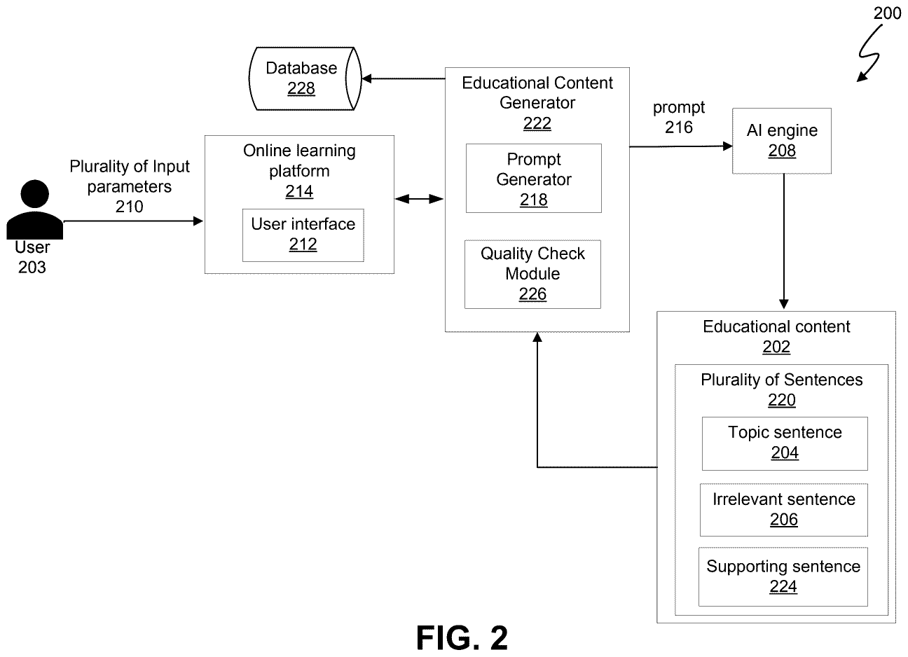

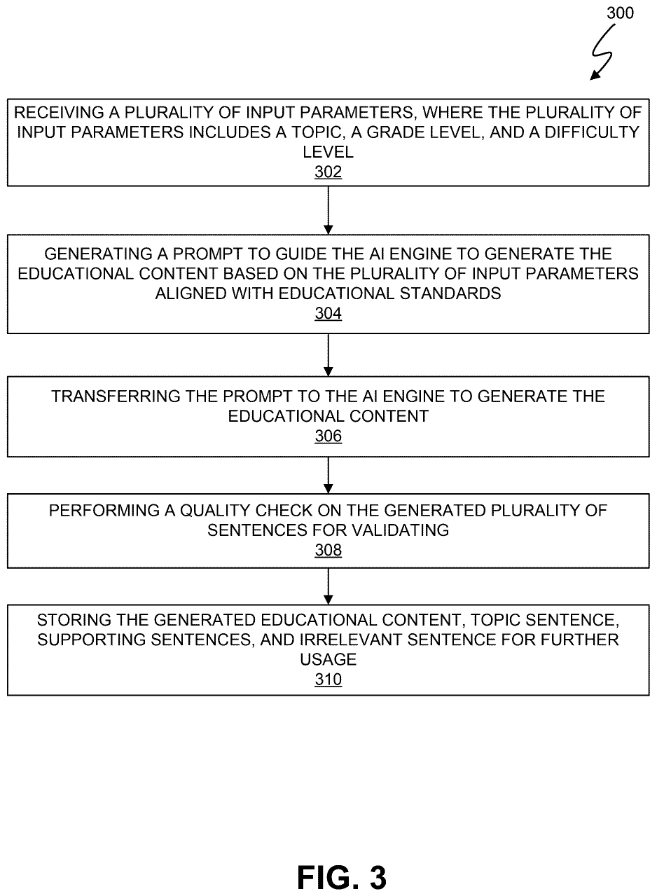

FIG. 2 depicts an educational content generation system 200 for generating an educational content 202 for a user 203 to identify a topic sentence 204 and an irrelevant sentence 206. FIG. 3 depicts an education content generation process 300 utilized by the educational content generation system 200.

An Artificial Intelligence (AI) engine 208 is designed to generate the educational content 202. The AI engine 208 receives a plurality of input parameters 210 from the user 203 via a user interface 212 of an online learning platform 214. The AI engine 208 utilizes the plurality of input parameters 210 and a prompt 216 generated by a prompt generator 218 to generate the educational content 202 for identification of a topic sentence 204 and irrelevant sentence 206 in the educational content 202.

Referring to FIGS. 2 and 3, in operation 302, the plurality of input parameters 210 are received via an educational content generator 222. The plurality of input parameters 210 includes a topic defining the subject matter of the educational content 202, a grade level indicating the reading and writing proficiency of the user 203, and a difficulty level specifying the complexity of the educational content 202.

The plurality of input parameters 210 refer to the data or values entered by the user 203 for determining the type of educational content 202 that will be generated by the educational content generation system 200. The plurality of input parameters 210 ensure that the requirements and preferences of the user 203 are identified. The plurality of input parameters 210 provides details about the kind of educational content 202 the user 203 seeks, including information related to the topic, grade level, and difficulty level. The educational content generator 222 received the plurality of input parameters 210 and provided to the prompt generator 218 to generate the prompt 216.

In at least one embodiment, the user interface 212 comprises graphical elements such as text fields, dropdown menus, and selection buttons that allow the user 203 to enter or choose their desired plurality of input parameters 210. The user interface 212 serves as a bridge that connects the user 203 with the educational content generation system 200, ensuring that the educational content 202 is generated based on the provided plurality of input parameters 210.

The user 203 is the individual who interacts with the user interface 212 to provide the plurality of input parameters 210. The user 203 may be a student, educator, or parent of the student seeking educational content 202. The plurality of input parameters 210 includes the topic, the grade level, and the difficulty level. The topic defines the subject matter of the educational content 202. It specifies the area of knowledge or academic discipline that the user 203 wishes to explore. The topic can cover a wide range of subjects, including mathematics, science, history, literature, and so forth. By specifying the topic, the user 203 ensures that the educational content 202 aligns with their interests and learning goals.

The subject matter refers to the specific content within a chosen topic that is covered in the educational content 202. The subject matter determines the focus of the learning experience and ensures that the provided content is relevant. The subject matter may include fundamental concepts, theories, principles, and practical applications related to the chosen topic. The grade level indicates the reading and writing proficiency of the user 203. The grade level enables the AI engine 208 to determine the complexity and depth of the educational content 202. Different grade levels correspond to varying levels of cognitive ability and comprehension skills. For example, the educational content 202 generated for elementary school students will differ significantly from the educational content 202 for high school or college-level learners.

The difficulty level of the educational content 202 is adjusted based on the level selected from easy, medium, and hard to regulate the length and complexity of the generated educational content 202. The easy difficulty level typically presents fundamental concepts with simple language, shorter text, and straightforward exercises to ensure accessibility for beginners. In contrast, the medium difficulty level introduces moderate-length content, and slightly challenging exercises to promote deeper understanding. At the hard difficulty level, the educational content 202 becomes complex, incorporating difficult terminology, in-depth analysis, and longer text or problem-solving activities.

The educational content 202 is the output generated based on the plurality of input parameters 210. It includes educational exercises such as multiple choice questions where the user 203 identify the topic sentence 204 and the irrelevant sentence 206. The educational content 202 is designed to align with the topic, grade level, and difficulty level selected by the user 203.

In operation 304, the prompt 216 is generated by the prompt generator 218 to guide the AI engine 208 to generate the educational content 202 based on the plurality of input parameters 210 aligned with educational standards.

The prompt 216 serves as a guiding element that directs the AI engine 208 to generate relevant and structured educational content 202. The prompt 216 involves formulating a set of instructions, parameters, and contextual elements that are utilized to generate the educational content. The prompt 216 is designed to ensure that the AI engine 208 produces the educational content 202 that is aligned with the educational standards. The prompt generator 218 is responsible for creating the prompt 216 based on the plurality of input parameters 210 provided by user 203.

The prompt generator 218 is a tool that constructs the prompt 216 that guides the AI engine 208 to generate the educational content 202. The prompt generator 218 analyzes the plurality of input parameters 210 to create the prompt 216. When the prompt 216 is generated it is then provided to the AI engine 208 to generate the educational content 202 such as a paragraph, article, passage, and so forth, aligned with the educational standards. In at least one embodiment, the prompt 216 is generated by the prompt engineer. In at least another embodiment, the skeleton of the prompt 216 is prepared by the prompt engineer and then the skeleton is provided to the prompt generator 218 to generate the prompt 216.

Below is an exemplary integration of programmatic logic, e.g. code, and generation of prompt 216 by the prompt generator 218 to generate the educational content 202.

The given prompt 216 generates education activities such as “eliminate irrelevant sentences” for user 203, specifically focusing on identifying topic sentence 204 and eliminating irrelevant sentences 206 activity. The main script main.ts orchestrates the execution of the workflow by iterating over different grade levels, difficulty levels, and curriculum topics. It uses concurrently control ‘p-limit’ to manage asynchronous tasks efficiently. The script defines functions to execute workflows, save results to a file, and generate structured question sets for the educational activity using Prisma. The workflow workflow.ts integrates OpenAI's language models to generate, validate, and refine educational content 202, such as paragraphs, ensuring that the created exercises meet specific criteria. The prompt.ts provide structured queries to guide the AI engine 208 in generating coherent and meaningful educational content 202.

The function generateIrrelevantSentence prompts the AI engine 208 to create a sentence that is thematically linked to the overall topic but doesn't fit logically to the central idea of the provided paragraph. This sentence is used to teach students how to spot irrelevant details in writing. The function splitParagraph instructs the AI engine 208 to break a single paragraph into individual sentences. The function then specifies that the response should be a JSON array, each element representing a distinct sentence from the paragraph. The function identifyTopicSentence asks the AI engine 208 to locate the topic sentence 204 in the given paragraph. The function irrelevantQA asks the AI engine 208 to decide whether a specific sentence is a suitable irrelevant sentence 206 for the given paragraph. The user expects a “Yes” or “No” answer depending on whether the sentence is unrelated enough, yet still tangentially connected to the overarching topic. The function checkWhichIsTheTopicSentence compares a proposed topic sentence 204 to the plurality of sentences 220. The AI engine 208 confirms or denies whether the proposed sentence can serve as the topic sentence 204 for the paragraph, responding with “Yes” or “No” accordingly.

The AI engine 208 generates paragraphs based on a given topic, then determines the topic sentence 204, splits the paragraph into the plurality of sentences 220, and creates the irrelevant sentence 206 for user 203 to identify. The process involves multiple validation steps, such as checking the quality of the topic sentence 204 and ensuring the irrelevant sentence 206 meets predefined criteria. By leveraging zod for schema based validation and OpenAI's GPT models for content generation and refinement, the workflow ensures generation of quality educational content. The final output consists of structured question data stored in Prisma, which can be presented to the user 203 on the user interface 212 to help the user 203 practice and improve his/her writing skills.

Here's an example paragraph: “When you push a toy car, it moves. This is because forces make things move. A balanced force keeps things still.” Here is an example of irrelevant sentence 06 for the example paragraph: “When the car moves, the wheel's spin.” It's a good irrelevant sentence 206 because the sentence is related to a car, but it doesn't talk about the topic of forces, which is what makes it irrelevant to the paragraph.

In operation 306, the prompt 216 is transferred to the AI engine 208 to generate the educational content 202.

The AI engine 208 generates the educational content 202 corresponding to the topic defining the subject as provided in the plurality of input parameters 210. In at least one embodiment, the AI engine 208 utilizes a Large Language model (LLM) to understand the structure, intent, and context of the prompt 216. The LLM is trained on extensive datasets comprising diverse textual information, enabling the AI engine 208 to generate coherent, contextually appropriate educational content 202. The AI engine 208 ensures that the generated content maintains linguistic quality, factual accuracy, and alignment with predefined educational standards.

The AI engine 208 split the generated content 202 into a plurality of sentences 220. The plurality of sentences 220 refers to the multiple sentences that collectively form the educational content 202. The AI engine 208 ensures that each sentence from the plurality of sentences 220 serves a distinct purpose in reinforcing learning objectives. The plurality of sentences 220 includes topic sentence 204, supporting sentences 224, and irrelevant sentence 206. The AI engine 208 categorizes the plurality of sentences 220 based on their function within the content structure, distinguishing between topic sentence 204, supporting sentences 224, and irrelevant sentence 206.

The topic sentence 204 is a sentence that defines the central idea or main theme of the educational content 202. The AI engine 208 identifies topic sentence 204 by analyzing the semantic structure of the plurality of sentences 220. The topic sentence 204 provides a clear and concise introduction to the subject matter. The AI engine 208 ensures that topic sentence 204 is accurately placed within the content. The supporting sentences 224 are sentences that provide additional information, explanations, examples, or evidence to reinforce the topic sentence 204. The supporting sentences 224 contribute to the depth and comprehensibility of the educational content 202 by elaborating on key concepts and providing context. The AI engine 208 processes the plurality of sentences 220 to identify supporting sentences 224, ensuring that they align with the topic sentence 204. The irrelevant sentence 206 is a sentence that does not contribute meaningfully to the educational content 202. Such sentences may be off-topic, redundant, or extraneous, potentially disrupting the coherence of the content.

The process of generating the topic sentence 204, supporting sentences 224, and identifying irrelevant sentences 206 begins by segmenting the educational content 202 into the plurality of sentences 220. The AI engine 208 analyzes each sentence from the plurality of sentences 220 individually and determines its role. The AI engine 208 analyzes the plurality of sentences 220 based on the logical sequence, coherence, and relevance to the main topic to categorize the plurality of sentences 220 effectively. Once the educational content 202 is divided into the plurality of sentences 220, the AI engine 208 evaluates each sentence from the plurality of sentences 220 to classify into the topic sentence 204, supporting sentences 224, and the irrelevant sentence 206.

The generation of the educational content 202 by the AI engine 208 based on the input parameters 210 ensures that each educational content 202 has a single coherent topic sentence 204, multiple supporting sentences 224, and one irrelevant sentence 206. By processing the plurality of input parameters 210, the AI engine 208 constructs the educational content 202 with a single coherent topic sentence 204 that introduces the main idea of the educational content 202. In addition to the topic sentence 204, the AI engine 208 generates multiple supporting sentences 224 that elaborate on the main theme by providing explanations, examples, or evidence. The supporting sentences 224 contribute to the logical development of the educational content 202, reinforcing key concepts and enhancing comprehension. Furthermore, the AI engine 208 includes one irrelevant sentence 206 within the generated educational content 202. This irrelevant sentence 206 serves as a tool for educational exercises, helping user 203 practice skills such as identifying off-topic or unnecessary information.

In operation 308, a quality check module 226 is used to perform quality check on the generated plurality of sentences 220 for validating if the topic sentence 204 includes the central idea or main theme of the educational content 202 and the irrelevant sentence 206 does not support the central idea or main theme of the educational content 202.

The quality check module 226 is used to validate the topic sentence 204 confirms the main theme of the educational content 204 and the irrelevant sentence 206 does not support the main theme of the educational content.

The quality check module 226 is designed to assess the quality and correctness of the topic sentence 204 and the irrelevant sentence 206. The validation module 226 applies a systematic approach to analyze the topic sentence 204 and the irrelevant sentence 206 within the educational content 202 to verify the topic sentence 204 accurately presents the main theme and that the irrelevant sentence 206 does not contribute to the overall instructional value.

The quality check module 226 performs automated checks to verify the structural and thematic integrity of the generated educational content 202. In at least one embodiment, the quality check module 226 utilizes natural language processing techniques, pattern recognition, and machine learning algorithms to evaluate whether each sentence from the plurality of sentences 220 within the educational content 202 adheres to the predefined learning objectives. The quality check module 226 is designed to analyze textual coherence, logical progression, and contextual relevance. The quality check module 226 assesses the topic sentence 204 to confirm that it accurately represents the subject matter covered within the educational content 202. This assessment involves checking for clarity, consistency with the intended learning objective, and alignment with the supporting sentences 224. The main theme of the educational content 202 refers to the core subject or central idea conveyed through the content.

The quality check module 226 cross-references the topic sentence 204 with the main theme to ensure that they are aligned. If discrepancies are detected, the quality check module 226 may flag inconsistencies and prompt further refinements to the generated content. The irrelevant sentence 206 is a sentence within the educational content 202 that does not contribute to the main theme. The quality check module 226 assesses whether the irrelevant sentence 206 is appropriately unrelated to the topic sentence 204 and the supporting sentences 226. It applies contextual analysis to differentiate between the plurality of sentences 220 that reinforce the main theme and those that do not. If the irrelevant sentence 206 fails to meet the criteria of being off-topic or misleading, the quality check module 226 may suggest modifications.

Moreover, semantic analysis is employed by the quality check module 226 to validate both the topic sentence 204 and the irrelevant sentence 206. This technique involves examining the meaning and relationships between words, phrases, and sentences to determine their relevance to the educational content 202. In at least one embodiment, the quality check module 226 leverages machine learning models trained on linguistic datasets to perform semantic analysis.

Furthermore, discarding the generated educational content 202 if the topic sentence 204 or irrelevant sentence 206 fails the validation process. The quality check module 226 assesses whether the topic sentence 204 correctly introduces the main theme and whether the irrelevant sentence 206 effectively deviates from the subject matter. If either of these sentences does not meet the required standards such as the topic sentence 204 being unclear, misaligned with the main theme, or the irrelevant sentence 206 not sufficiently distinct from the content, the entire educational content 202 is deemed unsuitable for learning purposes. Discarding such educational content 202 prevents the dissemination of inaccurate or poorly structured educational material, ensuring that only quality educational content reaches to the user 203.

Utilizing a heuristic method to check if the generated irrelevant sentence 206 is properly irrelevant by utilizing a Boolean to indicate whether the generated irrelevant sentence 206 meets the irrelevance criterion. The heuristic method relies on approximations and practical decision-making strategies to evaluate irrelevance efficiently. This approach enables to analyze the contextual meaning of the generated irrelevant sentence 206 in relation to the topic sentence 204 and supporting sentences 224. By implementing heuristic rules, the AI engine 208 can determine if the irrelevant sentence 206 sufficiently deviates from the core subject while still maintaining linguistic coherence. The heuristic method ensures that the irrelevant sentence 206 neither overlaps significantly with the educational content 202 nor introduces random, incomprehensible information that could confuse the user 203.

The Boolean indicator is employed to determine whether the generated irrelevant sentence 206 meets the irrelevance criterion. The Boolean is a binary variable that can take one of two values true or false allowing to make a clear decision on whether the irrelevant sentence 206 should be retained or discarded. The heuristic method processes the irrelevant sentence 206 by analyzing key attributes such as semantic distance, contextual deviation, and logical consistency. If the Boolean value evaluates to true, it signifies that the irrelevant sentence 206 has successfully met the irrelevance criterion, meaning it does not support or relate closely to the topic sentence 204. Conversely, if the Boolean value is false, the irrelevant sentence 206 fails validation and requires modification or replacement. This Boolean-based heuristic check ensures that the educational content 202 remains structured, effective, and aligned with instructions.

Moreover, a quality check response is presented to the user 203 in the form of a Boolean result, including a Pass if the identified topic sentence 204, and irrelevant sentence 206 passes the quality check, or a Fail if any of the identified topic sentence 204, or irrelevant sentence 206 fails to clear the quality check. This ensures that only well-structured and contextually appropriate sentences are approved.

In operation 310, the generated educational content 202, topic sentence 204, supporting sentences 224, and irrelevant sentence 206 are stored in a database 230 for further usage.

The database 228 acts as a repository where generated content is systematically recorded, allowing seamless access to educational content 202 whenever needed. The database 228 ensures that each component of the generated content is appropriately categorized and indexed, facilitating efficient search and retrieval operations. The structured format used for storing the content enables the online learning platform 214 to dynamically present relevant materials to the user 203 based on the plurality of input parameters 210 such as grade level, subject, difficulty level, and educational standards.

In at least one embodiment, when storing the content in the database 228, it is essential to classify it under appropriate categories to ensure structured access. The generated educational content 202 is tagged with metadata, including subject, complexity level, and relevant curriculum standards, to optimize retrieval. In at least another embodiment, the database 228 may employ relational models, NoSQL databases, or other data management techniques to accommodate volumes of educational content 202.

Moreover, data security is essential for storing generated educational content 202 in the database 228. In at least one embodiment, the database 228 implements access controls, encryption mechanisms, and authentication protocols to protect sensitive educational materials. The process of storing educational content 202 in the database 228 involves version control mechanisms to track changes and updates to stored materials. Storing multiple versions of educational content 202 ensures that historical records are maintained while allowing for iterative improvements to instructional materials.

Moreover, combining the validated topic sentence 204, supporting sentences 224, and the irrelevant sentence 206 into a single data structure for delivering on the online learning platform 214 and storing in the database 228. The single data structure format allows the educational content 202 to be accessed, retrieved, and processed while maintaining logical coherence. This data structure may be implemented using formats such as JSON, XML, or a relational database schema, where each element such as topic sentence 204, supporting sentences 224, and irrelevant sentence 206 are categorized under clearly defined fields. The single data structure facilitates content reuse, indexing, and searchability, allowing the management and modification of the stored educational content 202 when necessary.

Storing the combined educational content 202 in the database 228 ensures that the online learning platform 214 maintains a repository of validated materials for future use. The database 228 acts as a centralized storage system where each piece of content is cataloged with relevant metadata, such as subject, grade level, difficulty, and timestamp, enabling efficient retrieval and customization. By structuring the educational content 202 in an organized manner, the online learning platform 214 can dynamically generate learning modules customized to individual learners based on their progress and preferences.

The database 228 utilizes Zod schemas to ensure the validated topic sentence 204, supporting sentences 224, and irrelevant sentence 206 are in the correct structure.

The Zod is a schema based library, that provides a mechanism for defining data structures and validating the integrity of the topic sentence 204, supporting sentences 224, and irrelevant sentence 206. By implementing Zod schemas, the database 228 ensures that each educational content 202 adheres to predefined rules, such as data types, required fields, and character limits. This validation step prevents inconsistencies and errors in data storage by catching malformed or incomplete entries before they are committed to the database 228. Additionally, the Zod allows for type-safe parsing, meaning that the topic sentence 204, supporting sentences 224, and irrelevant sentence 206 are validated at runtime.

The generated topic sentence 204, supporting sentences 224, and irrelevant sentence 206 are displayed on the user interface 212 of the online learning platform 214 via the educational content generator 222. The user interface 212 is designed to be intuitive, visually appealing, and easy to navigate so that the user 203 can effortlessly access the educational content 202. The generated topic sentence 204, supporting sentences 224, and irrelevant sentence 206 appear in a structured format. The topic sentence 204 is displayed on the user interface 212, ensuring that the user 203 can easily identify the primary idea being discussed. The displayed topic sentence 204, supporting sentences 224, and irrelevant sentence 206 are not too obvious for the user 203 to guess, such as the displayed sentences are not in bold text, highlighted sections, or distinct placement that allow the user 203 to easily distinguish the topic sentence 204 and irrelevant sentence 206 from the supporting sentences 224.

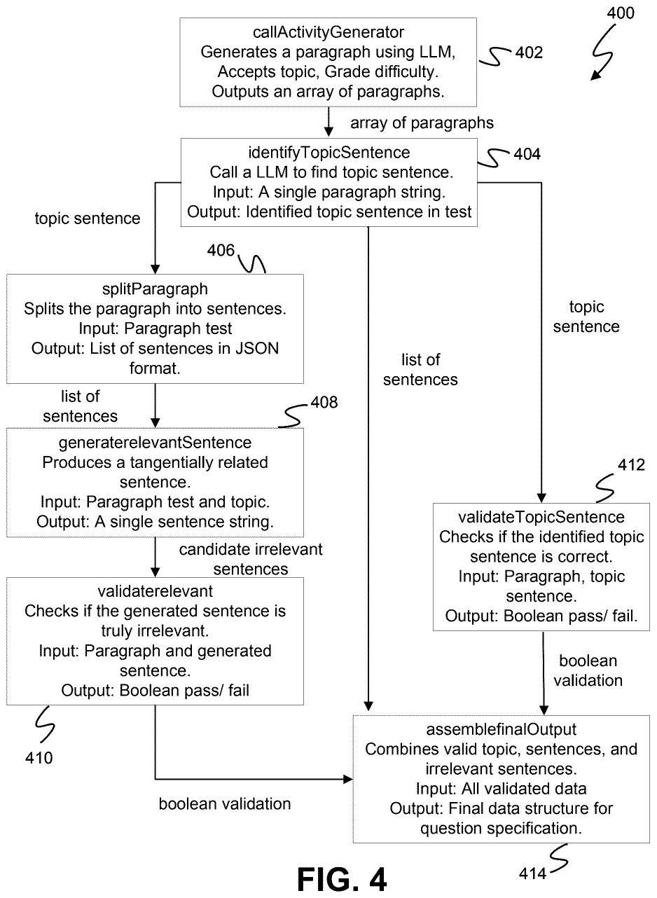

FIG. 4 depicts an educational content validation process 400, which is an embodiment of the educational content generation process 300 of FIG. 3. A callActivityGenerator 402, obtains the educational content 202 about a given topic that meets grade and difficulty specifications. The educational content 202 is generated based on the plurality of input parameters 210. An identifyTopicSentence 404 detects which sentence from the plurality of sentences 220 in the educational content 202 introduces the central idea to identify the topic sentence 204. The AI engine 208 is configured to identify the topic sentence 204 from the plurality of sentences 220. A splitParagraph 406, divides the educational content 202 into the plurality of sentences 220. A generateIrrelevantSentence 408, produces one sentence that is tangentially related but irrelevant to the main theme of the educational content 202. The sentence represents the irrelevant statement 206. A validateIrrelevant 410, utilizes the AI engine 208 to check if the generated irrelevant sentence 206 is properly irrelevant. A Boolean is utilized to indicate whether the generated irrelevant sentence 206 meets the irrelevance criterion. A validateTopicSentence 412, confirms that the detected topic sentence 204 introduces the main idea of the education content 202. An assembleFinalOuput 414, combines the validated topic sentence 204, supporting sentences 224, and the irrelevant sentence 206 into a single data structure for displaying on the user interface 212 of the online learning platform 214.

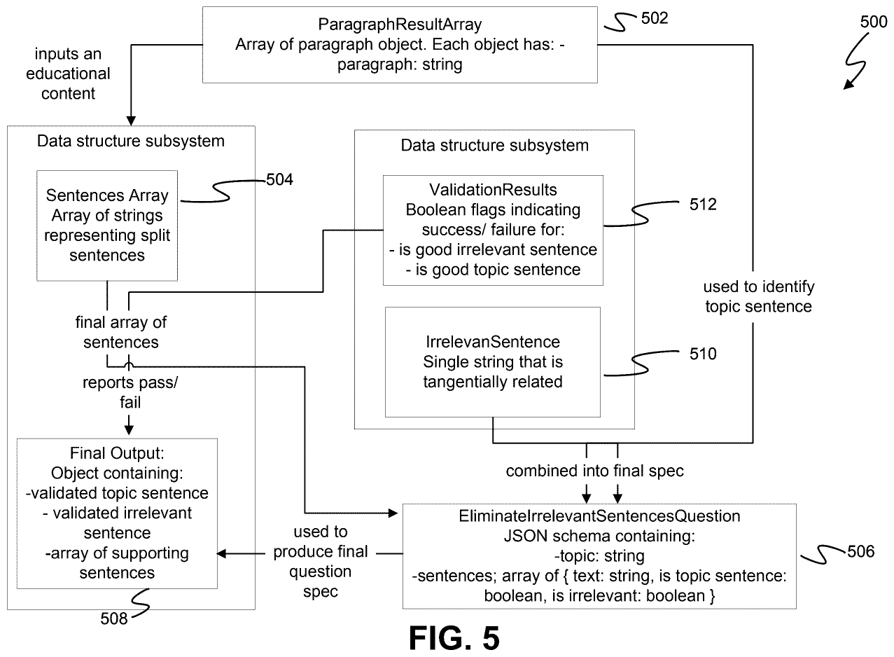

FIG. 5 depicts an output generation process 500, which is an embodiment of the educational content generation process 300 of FIG. 3. A ParagraphResultArray 502, stores the educational content 202 generated by the AI engine 208 for a single run (often multiple educational content are generated). The ParagraphResultArray 502 inputs the educational content 202 to a Sentences Array 504 that contains the plurality of sentences 220. An EliminateIrrelevantSentencesQuestion 506, includes the topic and plurality of sentences 220 such as the topic sentence 204, irrelevant sentence 206, or supporting sentences 224. A FinalOutput 508 stores the result used for either storage in the database 228 or transmission to the user interface 212. An IrrelevantSentence 510, string that includes the irrelevant sentences 206 in the final question presented to the user 203 is set to distract them. A ValidationResults 512, contains the pass/fail booleans from validating the topic sentence 204 and the irrelevant sentence 206. If the validations fail, the data is pruned, and the final output is not formed.

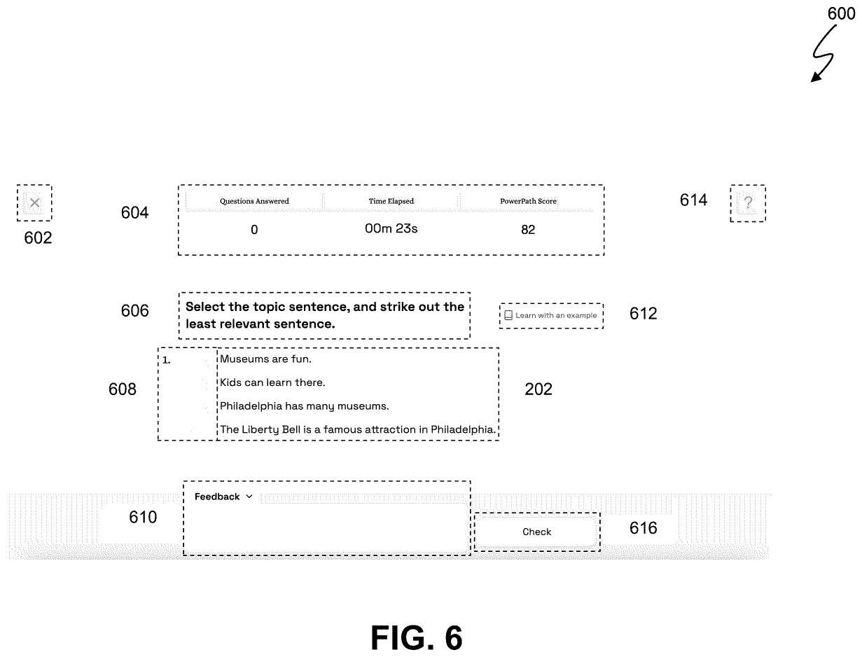

FIG. 6 is an exemplary user interface 600 depicting a generated ‘topic sentence and irrelevant sentence identification’ activity on an online learning platform 214. As shown “X” button 602 on which user 203 click to close the activity which is currently displayed on the online learning platform 214. A session info display 604 displays a readout of current session information, such as a number of questions answered by the user 203, time taken to complete the exercise, and a powerpath score to show the score of the user 203. An instructions bar 606 provides details about the current task. The educational content 202 is provided to the user 203 and the user 203 engages with the education content 203 based on the instruction 606 provided. A response fields 608 is provided for the user 203 to input the response. A feedback bar 610 displays generated feedback to user inputs. A learn with an example tab 612 displays an instructional popup to explain how to perform the exercise when the user 203 clicks on it. A help tab 614 (indicated by a question mark), opens an instructional popup to help the user 203. A check button 616, on the user 203 click, submits response for grading.

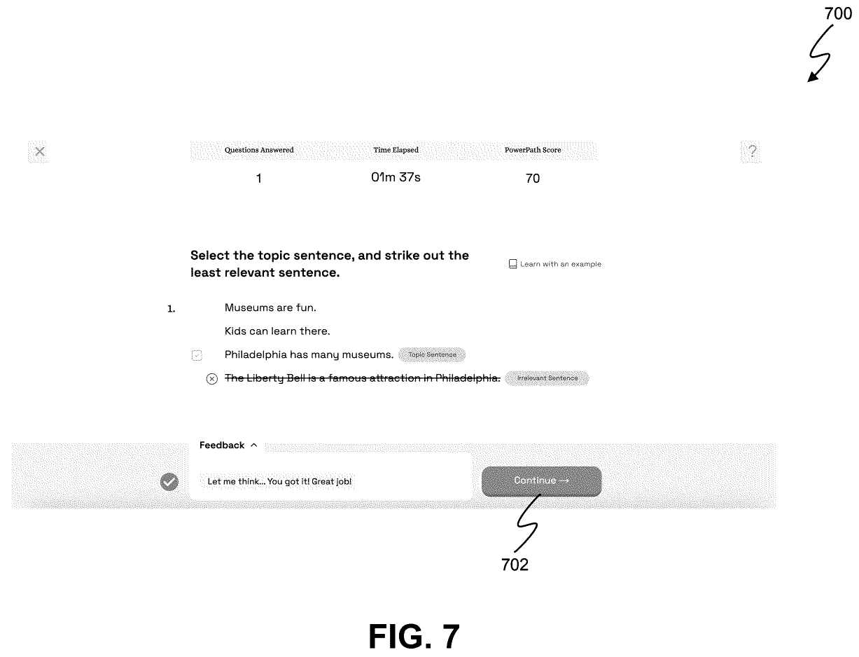

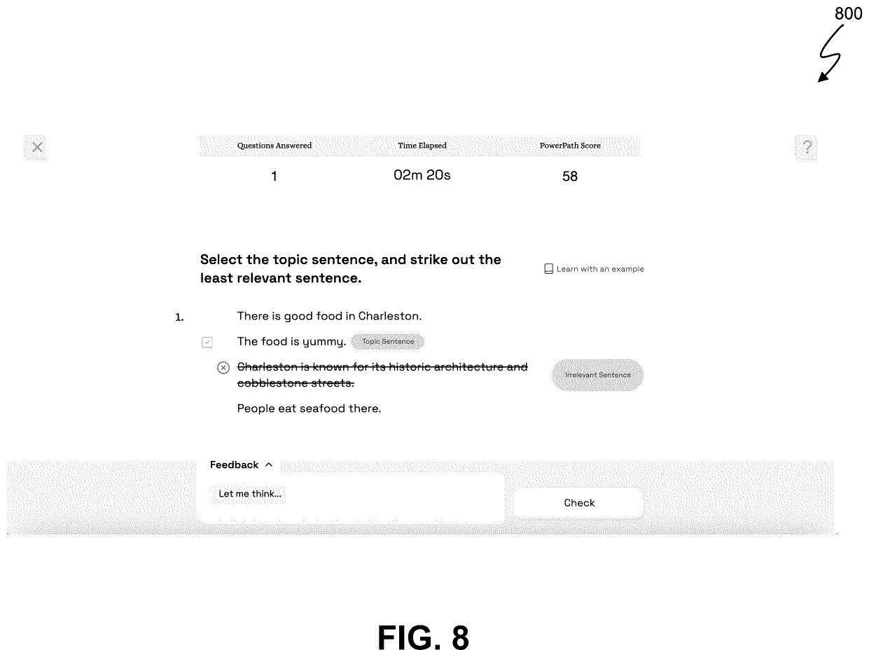

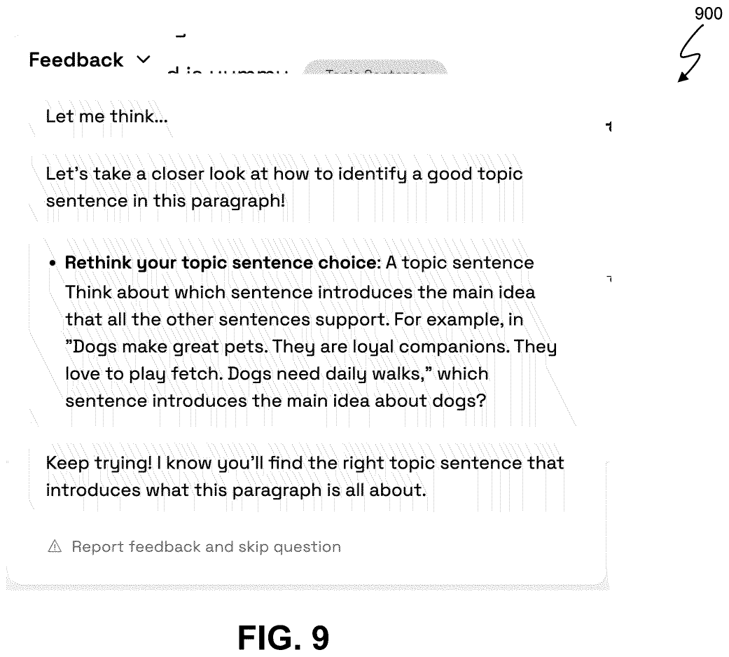

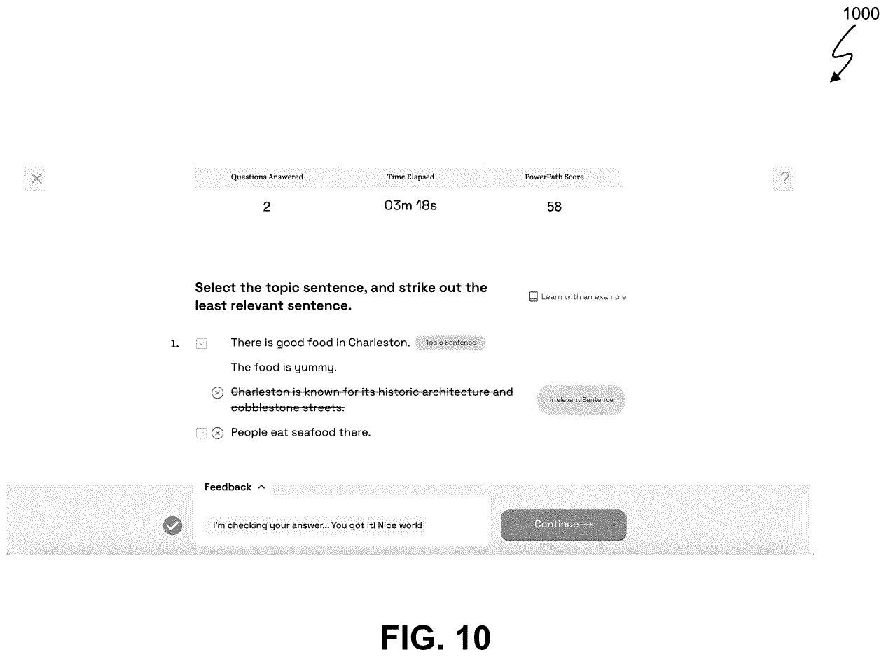

FIGS. 7-14 are exemplary user interfaces 700, 800, 900, 1000, 1100, 1200, 1300, and 1400 depicting interaction of the user 203 with the online learning platform 214. Referring to FIG. 7 depicts the user interface 700 where the user 203 correctly answered the question. Once the answer given by the user 203 is correct, the check button 616 changes into a continue button 702. Referring to FIG. 8 depicts the user interface 800 where the user 203 incorrectly answered the question. As shown, a reason is provided for the incorrect answer. Herein the topic sentence 204 is wrong. FIG. 9 depicts the user interface 900, when the user 203 incorrectly answered the question as shown in FIG. 8. A feedback is generated and is provided to the user 203 to provide the correct answer. FIG. 10 depicts the user interface 1000, after reading the feedback, the user 203 can again attempt the question. As shown in FIG. 10 the user submits the correct answer after the feedback.

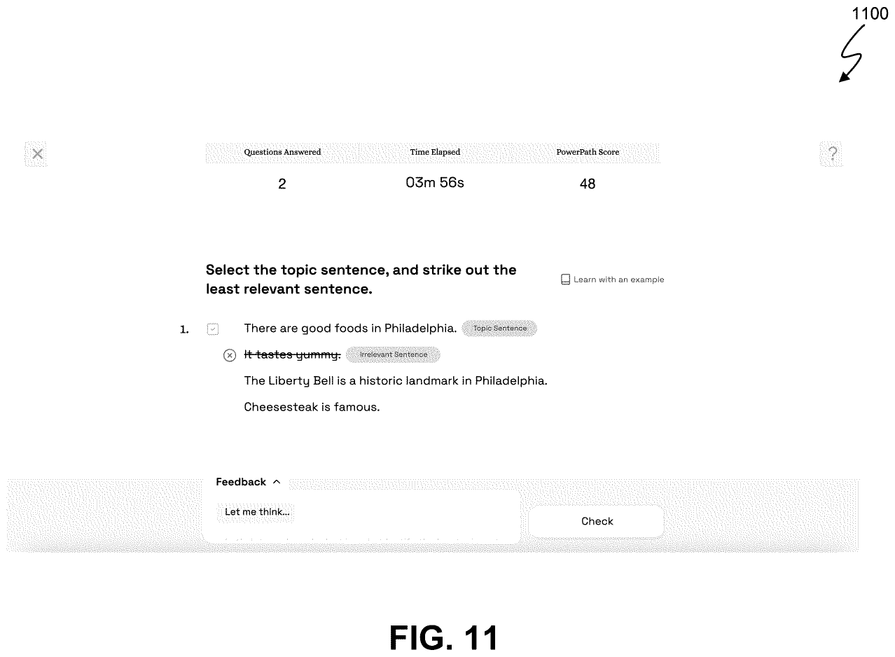

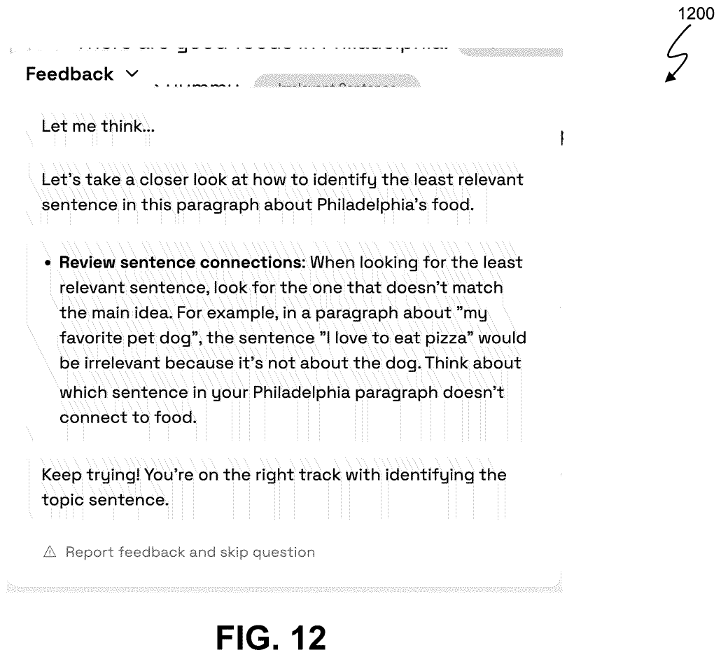

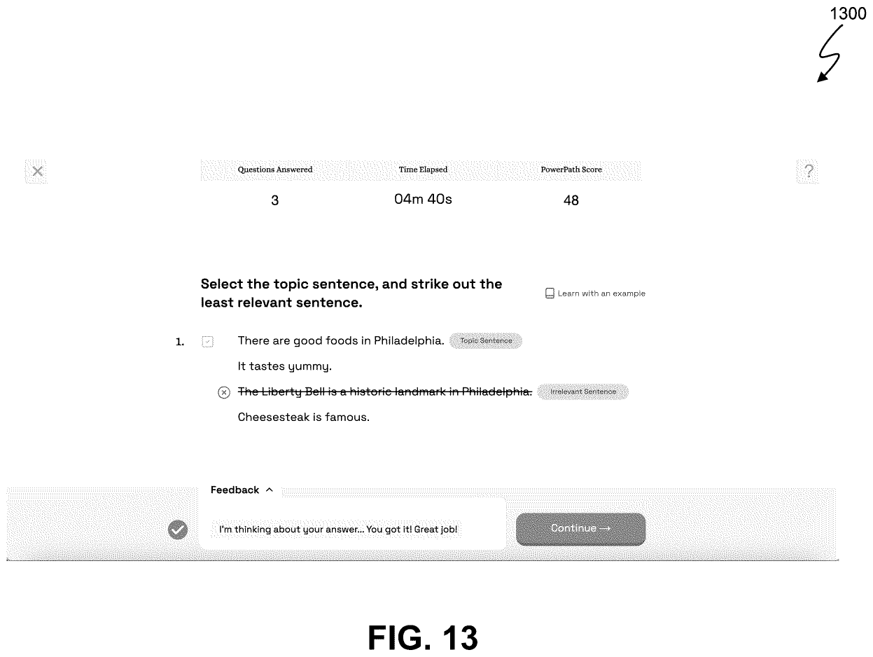

Referring to FIG. 11 depicts the user interface 1100 where the user 203 incorrectly answered the question. As shown, a reason is provided for the incorrect answer. Herein the irrelevant sentence 206 is wrong. FIG. 12 depicts the user interface 1200, when the user 203 incorrectly answered the question as shown in FIG. 11. The feedback is generated and is provided to the user 203 to provide the correct answer. FIG. 13 depicts the user interface 1300, after reading the feedback, the user 203 can again attempt the question. As shown in FIG. 13 the user submits the correct answer after the feedback

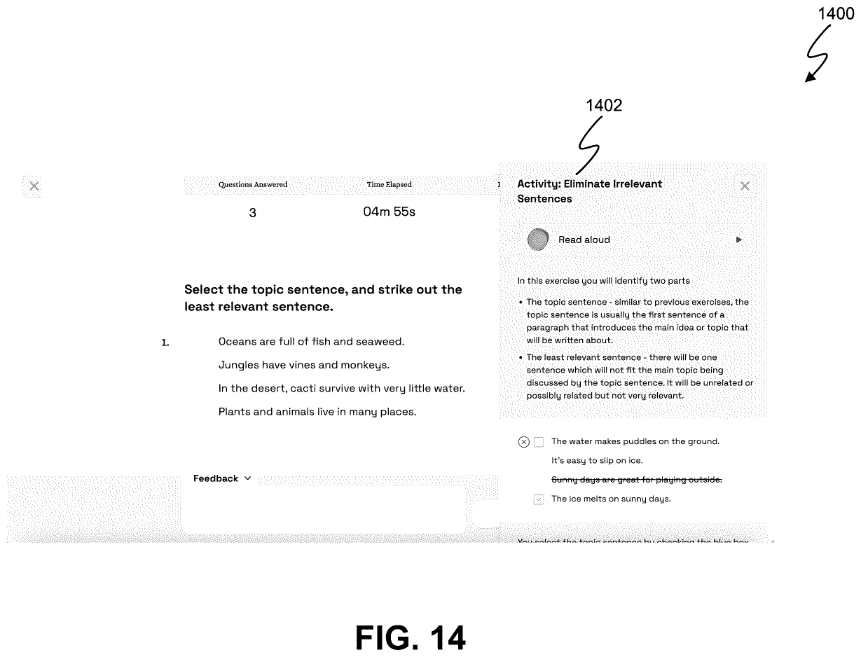

Referring to FIG. 14 depicts the user interface 1400, when the user 203 clicks on the learn with an example tab 612 an example popup tab 1402 is displayed on the user interface 1400 which help the user 203 to answer the question.

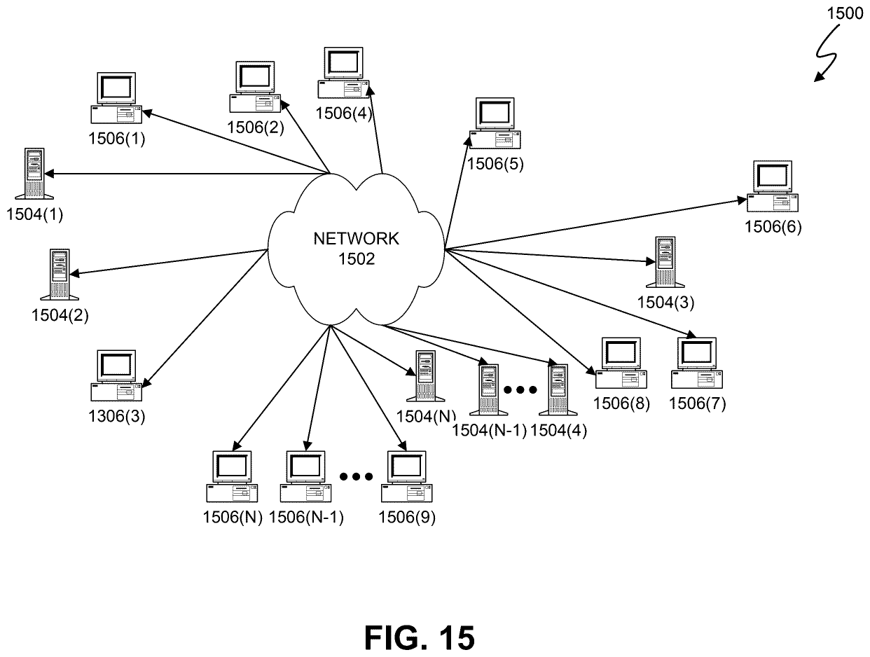

FIG. 15 is a block diagram illustrating a network environment 1500 in which an educational content generation system 200 and education content generation process 300 may be practiced. Network 1502 (e.g. a private wide area network (WAN) or the Internet) includes a number of networked server computer systems 1504(1)-(N) that are accessible by client computer systems 1506(1)-(N), where N is the number of server computer systems connected to the network. Communication between client computer systems 1506(1)-(N) and server computer systems 1504(1)-(N) typically occurs over a network, such as a public switched telephone network over asynchronous digital subscriber line (ADSL) telephone lines or high-bandwidth trunks, for example communications channels providing T1 or OC3 service. Client computer systems 1506(1)-(N) typically access server computer systems 1504(1)-(N) through a service provider, such as an internet service provider (“ISP”) by executing application specific software, commonly referred to as a browser, on one of client computer systems 1506(1)-(N).

Client computer systems 1506(1)-(N) and/or server computer systems 1504(1)-(N) are specialized computer programmed to improve conventional computer systems to implement and utilize the educational content generation system 200 and education content generation process 300. The type of computer system that can be specially programmed to implement and utilize the educational content generation system 200 and education content generation process 300 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the educational content generation system 200 and education content generation process 300 can be implemented using code stored in a tangible, non-transient computer readable medium and executed by one or more processors. In at least one embodiment, the educational content generation system 200 and education content generation process 300 can be implemented completely in hardware using, for example, logic circuits and other circuits including field programmable gate arrays.

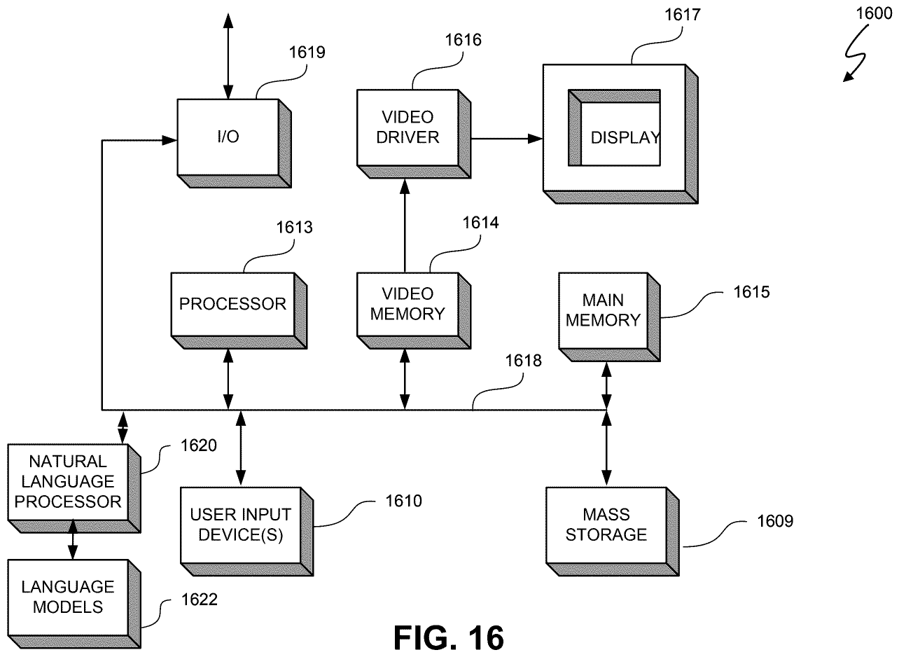

Embodiments of the educational content generation system 200 and education content generation process 300 can be implemented on a computer system such as a special-purpose, special-programmed computer 1600 illustrated in FIG. 16. Input user device(s) 1610, such as a keyboard and/or mouse, are coupled to a bi-directional system bus 1618. The input user device(s) 1610 are for introducing user input to the computer system and communicating that user input to processor 1613. The computer system of FIG. 16 generally also includes a non-transitory video memory 1614, non-transitory main memory 1615, and non-transitory mass storage 1609, all coupled to bi-directional system bus 1618 along with input user device(s) 1610 and processor 1613. The mass storage 1609 may include both fixed and removable media, such as a hard drive, one or more CDs or DVDs, solid state memory including flash memory, and other available mass storage technology. Bus 1618 may contain, for example, 32 of 64 address lines for addressing video memory 1614 or main memory 1615. The system bus 1618 also includes, for example, an n-bit data bus for transferring DATA between and among the components, such as CPU 1609, main memory 1615, video memory 1614 and mass storage 1609, where “n” is, for example, 32 or 64. Alternatively, multiplex data/address lines may be used instead of separate data and address lines.

I/O device(s) 1619 may provide connections to peripheral devices, such as a printer, and may also provide a direct connection to a remote server computer systems via a telephone link or to the Internet via an ISP. I/O device(s) 1619 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1609, into main memory 1615 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1615 is comprised of dynamic random access memory (DRAM). Video memory 1614 is a dual-ported video random access memory. One port of the video memory 1614 is coupled to video amplifier 1616. The video amplifier 1616 is used to drive the display 1617. Video amplifier 1616 is well known in the art and may be implemented by any suitable means. This circuitry converts pixel DATA stored in video memory 1614 to a raster signal suitable for use by display 1617. Display 1617 is a type of monitor suitable for displaying graphic images.

The computer system described above is for purposes of example only. The educational content generation system 200 and education content generation process 300 may be implemented in any type of computer system or programming or processing environment. It is contemplated that the educational content generation system 200 and education content generation process 300 might be run on a stand-alone computer system, such as the one described above. The educational content generation system 200 and education content generation process 300 might also be run from a server computer systems system that can be accessed by a plurality of client computer systems interconnected over an intranet network. Finally, the educational content generation system 200 and education content generation process 300 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is

1. A method for guiding an Artificial Intelligence (AI) engine for generating educational content for a user to identify a topic sentence and an irrelevant sentence within the educational content, the method comprising:
executing code using one or more processors of a computer system to cause the computer system to perform operations comprising:
receiving a plurality of input parameters, wherein the plurality of input parameters includes a topic defining subject matter of the educational content, a grade level, and a difficulty level specifying complexity of the educational content;
generating a prompt to guide the AI engine to generate the educational content based on the plurality of input parameters;
transferring the prompt to the AI engine to generate the educational content, wherein the AI engine is configured to perform operations comprising:
generating the educational content corresponding to the plurality of input parameters;
splitting the generated educational content into a plurality of sentences, wherein the plurality of sentences include a topic sentence, an irrelevant sentence, and multiple supporting sentences; and
processing the generated plurality of sentences to identify the topic sentence, supporting sentences, and the irrelevant sentence;
performing a quality check on the generated plurality of sentences to validate if:
the topic sentence is defining central idea of the educational content; and
the irrelevant sentence does not support the central idea of the educational content;
storing the validated topic sentence, supporting sentences, and irrelevant sentence in a database for further usage.

2. The method of claim 1 wherein the difficulty level of the educational content is selected from easy, medium, and hard to regulate the length and complexity of the generated educational content.

3. The method of claim 1 wherein the generation of the educational content is based on the plurality of input parameters ensures that each educational content has a single coherent topic sentence, multiple supporting sentences, and one irrelevant sentence.

4. The method of claim 1 wherein the generation of the topic sentence, and the irrelevant sentence requires splitting the education content into the plurality of sentences.

5. The method of claim 1, further comprises:
discarding the generated educational content if the topic sentence or irrelevant sentence fails the quality check.

6. The method of claim 1 wherein the validated topic sentence, supporting sentences, and the irrelevant sentence are combined together into a single data structure in the form of a question while storing them in a database, wherein the question is presented to a user via a user interface of an online learning platform.

7. The method of claim 1, further comprising;
utilizing a schema based validation approach to ensure that the topic sentence, supporting sentences, and irrelevant sentences are in a predefined format.

8. The method of claim 1 wherein a quality check response is presented to the user in the form of a Boolean result, including a Pass if the identified topic sentence, and irrelevant sentence passes the quality check, or a Fail if any of the identified topic sentence, or irrelevant sentence fails to clear the quality check.

9. The method of claim 1 wherein the generated educational content is presented to the user or stored in the database in JSON format.

10. The method of claim 1, further comprises:
implementing a concurrency control mechanism to limit the number of simultaneous AI engine calls to prevent the AI engine overload, wherein the concurrency control mechanism restricts the number of requests a user or system can make within a specific timeframe to avoid AI engine overload.

11. A system for guiding an Artificial Intelligence (AI) engine to generate educational content for a user to identify a topic sentence and an irrelevant sentence within the educational content, the method comprising:
one or more processors; and
a memory, coupled to the one or more processors, that stores code and execution of the code by the one or more processors causes the computer system to perform operations comprising:
receiving a plurality of input parameters, wherein the plurality of input parameters includes a topic defining subject matter of the educational content, a grade level, and a difficulty level specifying complexity of the educational content;
generating a prompt to guide the AI engine to generate the educational content based on the plurality of input parameters;
transferring the prompt to the AI engine to generate the educational content, wherein the AI engine is configured to perform operations comprising:
generating the educational content corresponding to the plurality of input parameters;
splitting the generated educational content into a plurality of sentences, wherein the plurality of sentences include a topic sentence, an irrelevant sentence, and multiple supporting sentences; and
processing the generated plurality of sentences to identify the topic sentence, supporting sentences, and the irrelevant sentence;
performing a quality check on the generated plurality of sentences for validating if:
the topic sentence is defining central idea of the educational content; and
the irrelevant sentence does not support the central idea of the educational content;
storing the validated topic sentence, supporting sentences, and irrelevant sentence in a database for further usage.

12. The system claim 11, wherein the difficulty level of the educational content is selected from easy, medium, and hard to regulate the length and complexity of the generated educational content.

13. The system of claim 11, wherein the generation of the educational content is based on the plurality of input parameters ensures that each educational content has a single coherent topic sentence, multiple supporting sentences, and one irrelevant sentence.

14. The system of claim 11, wherein the generation of the topic sentence, and the irrelevant sentence requires splitting the education content into the plurality of sentences.

15. The system of claim 11 further comprising:
discarding the generated educational content if the topic sentence or irrelevant sentence fails the validation process.

16. The system of claim 11 wherein the validated topic sentence, supporting sentences, and the irrelevant sentence are combined together into a single data structure in the form of a question while storing them in a database, wherein the question is presented to a user via a user interface of an online learning platform

17. The system of claim 11 further comprising:
utilizing a schema based validation approach to ensure that the topic sentence, supporting sentences, and irrelevant sentences are in a predefined format.

18. The system of claim 11 further comprises:
implementing a concurrency control mechanism to limit the number of simultaneous AI engine calls to prevent the AI engine overload, wherein the concurrency control mechanism restricts the number of requests a user or system can make within a specific timeframe to avoid AI engine overload.

19. The system of claim 11, wherein a quality check response is presented to the user in the form of a Boolean result, including a Pass if the identified topic sentence, and irrelevant sentence passes the quality check, or a Fail if any of the identified topic sentence, or irrelevant sentence fails to clear the quality check.

20. The system of claim 11, wherein the generated educational content is presented to the user or stored in the database in JSON format.
